(19) United States
(12) Patent Application Publication
(10) Pub. No.: US 2016/0131851 A1
(43) Pub. Date: May 12, 2016

(54) FIBER OPTIC CONNECTOR

(71) Applicant: CORNING OPTICAL COMMUNICATIONS LLC, Hickory, NC (US)

(72) Inventor: Thomas Theuerkorn, Hickory, NC (US)

(21) Appl. No.: 14/926,287

(22) Filed: Oct. 29, 2015

Related U.S. Application Data
(60) Provisional application No. 62/076,139, filed on Nov. 6, 2014.

(51) Int. Cl. G02B 6/38

(52) U.S. Cl. CPC G02B 6/3851; G02B 6/3821

(57) ABSTRACT

A fiber optic connector includes a ferrule assembly having a ferrule extending along a longitudinal axis and a ferrule holder from which the ferrule extends. The ferrule holder has an outer surface with a first keying feature. The fiber optic connector also includes a housing in which the ferrule holder is received. The housing has an inner surface with a second keying feature that cooperates with the first keying feature to limit rotation of the ferrule holder about the longitudinal axis. The ferrule holder is movable relative to the housing along the longitudinal axis between an unmated position and a mated position. A minimum clearance between the first keying feature and second keying feature is greater in the mated position than in the unmated position.

### PRIORITY APPLICATION

This application claims the benefit of priority under 35 U.S.C. §119 of U.S. Provisional Application Ser. No. 62/076,139, filed on Nov. 6, 2014, the content of which is relied upon and incorporated herein by reference in its entirety.

### BACKGROUND

This disclosure relates generally to optical communications, and more particularly to fiber optic connectors.

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, fiber optic connectors are often provided on the ends of fiber optic cables. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” fiber optic connector).

Regardless of where installation occurs, a fiber optic connector typically includes a ferrule with one or more bores that receive one or more optical fibers. The ferrule supports and positions the optical fiber(s) with respect to a housing of the fiber optic connector. Thus, when the housing of the fiber optic connector is mated with another connector (e.g., in an adapter), an optical fiber in the ferrule is positioned in a known, fixed location relative to the housing. This allows an optical connection to be established when the optical fiber is aligned with another optical fiber provided in the mating connector.

Some fiber optic connectors, such those having angled physical contact (APC) or tuned ferrules, must be rotationally aligned when mated to establish an effective optical connection. Thus, the rotational orientation of the ferrule with respect to the housing in such connectors must be closely controlled so that the rotational orientation is known prior to mating. This is typically accomplished by having a small clearance (tight fit) between keying features on a ferrule assembly and the housing. The keying features limit rotation of the ferrule assembly relative to the housing.

One of the challenges associated with having a tight fit between keying features is that a fiber optic connector may be subjected to various forces when during handling, particularly when mated in an adapter. The forces may result in deformation and/or displacement of the housing relative to the adapter. Such deformation and/or displacement may be greater than the gap between the keying features on the ferrule assembly and housing, resulting in forces being kinetically transferred to the ferrule assembly. The transfer of forces may result in rotational misalignment and/or radial offset between the optical fiber(s) in the mated ferrules, thereby affecting optical performance.

### SUMMARY

Embodiments of a fiber optic connector are disclosed below. According to one embodiment, a fiber optic connector includes a ferrule assembly having a ferrule extending along a longitudinal axis and a ferrule holder from which the ferrule extends. The ferrule is configured to support at least one optical fiber. The ferrule holder has an outer surface with a first keying feature. The fiber optic connector also includes a housing in which the ferrule holder is received. The housing has an inner surface with a second keying feature that cooperates with the first keying feature to limit rotation of the ferrule holder about the longitudinal axis. The ferrule holder is movable relative to the housing along the longitudinal axis between an unmated position and a mated position, with the ferrule holder being closer to a front end of the housing in the unmated position than in the mated position. A minimum clearance between the first keying feature and second keying feature is greater in the mated position than in the unmated position.

According to another embodiment, a fiber optic connector includes a ferrule assembly having a ferrule extending along a longitudinal axis and a ferrule holder from which the ferrule extends. The ferrule is configured to support at least one optical fiber. The ferrule holder has an outer surface with a first keying feature. The fiber optic connector also includes a housing having a cavity in which the ferrule assembly is received, with the ferrule assembly being movable relative to the housing along the longitudinal axis. The housing also has an inner surface with a second keying feature that cooperates with the first keying feature to limit rotation of the ferrule assembly about the longitudinal axis. In this embodiment, the ferrule assembly is biased toward a forward position in which a portion of the ferrule holder abuts a portion of the housing to retain the ferrule assembly within the housing. The first keying feature comprises one of a key or a groove, and the second keying feature comprises the other of the key or the groove. A minimum clearance between the key and the groove increases when the ferrule assembly moves in a rearward direction from the forward position along the longitudinal axis.

References to “a first keying feature” and “a second keying” above and in the description and claims below does not preclude the possibility of there being multiples of each keying feature. In some embodiments, for example, the ferrule holder may include a plurality (i.e., two or more) of the first keying features and the housing may include a plurality of the second keying features, with each of the first keying features cooperating with a corresponding one of the second keying features to limit rotation of the ferrule holder relative to the housing. Thus, “a first keying feature” refers to “at least one first keying feature.” Likewise, “a second keying feature” refers to “at least one second keying feature.”

Additional features and advantages will be set forth in the detailed description which follows, and in part will be readily apparent to those skilled in the technical field of optical communications. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 a perspective view of an example of a fiber optic connector;

FIG. 2 is an perspective view the fiber optic connector of FIG. 1;

FIG. 3 is a partially cut-away, perspective view of a housing of the fiber optic connector of FIG. 1;

FIG. 4 is a partially cut-away, perspective view of the housing in FIG. 3 from a different angle, showing a ferrule holder of the fiber optic connector loaded in the housing;

FIG. 5 is a partially cut-away, perspective view of the ferrule holder from FIG. 4 in an unmated/forward position in the housing;

FIG. 5A is a schematic view of a first keying feature on the ferrule holder cooperating with a second keying feature on the housing when the ferrule holder is in the unmated/forward position;

FIG. 6 is a partially cut-away, perspective view similar to FIG. 5, but showing the ferrule holder in a mated/rearward position in the housing;

FIG. 6A is a schematic view of the first keying feature on the ferrule holder cooperating with the second keying feature on the housing when the ferrule holder is in the mated/rearward position;

FIG. 7 is a rear elevation view of the ferrule holder of the fiber optic connector of FIG. 1 loaded into the housing; and

FIG. 8 is a schematic view illustrating the position of the first and second keying features with reference to a Cartesian coordinate system.

### DETAILED DESCRIPTION

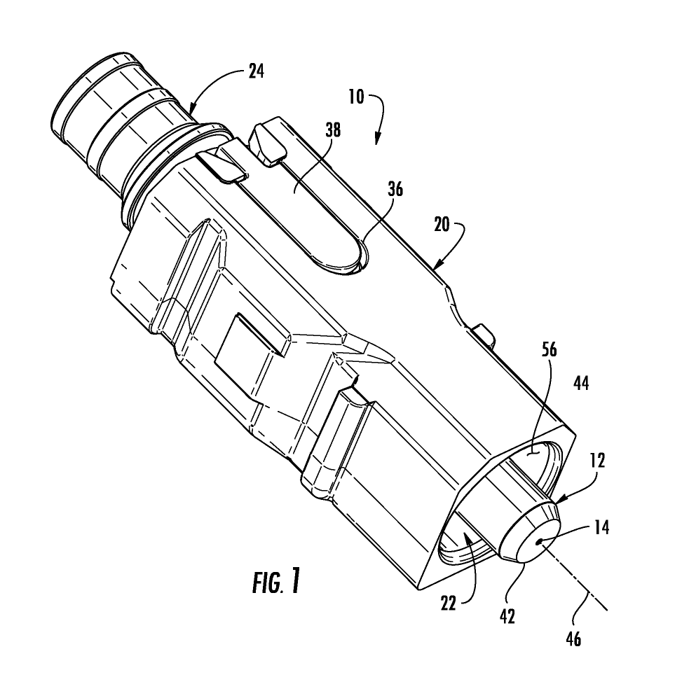

Various embodiments will be further clarified by examples in the description below. In general, the description relates fiber optic connectors and cable assemblies including the same. One example of a fiber optic connector 10 (also referred to as “optical connector 10”, or simply “connector 10”) is shown in FIG. 1. Although the connector 10 is shown in the form of a SC-type connector, the features described below may be applicable to different connector designs. This includes ST, LC, FC, MU, and MPO-type connectors, for example, and other single-fiber or multi-fiber connector designs.

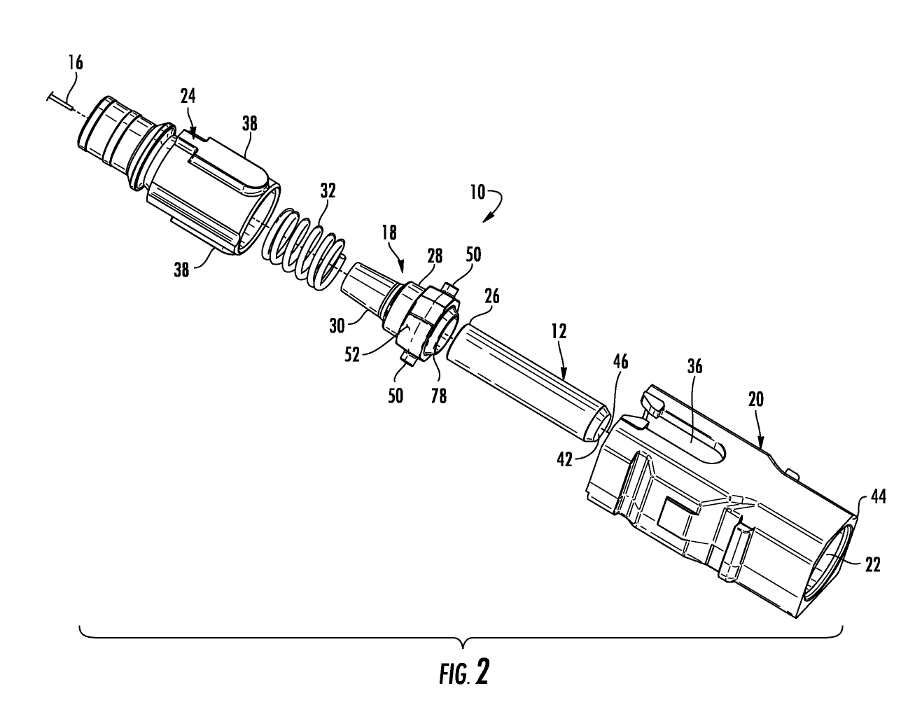

As shown in FIGS. 1 and 2, the connector 10 includes a ferrule 12 having a ferrule bore 14 (“micro-hole”) configured to support an optical fiber 16, a ferrule holder 18 from which the ferrule 12 extends, an outer housing 20 (“housing 20”) having a cavity 22 in which the ferrule holder 18 is received, and a retention body 24 (also referred to as “inner housing 24” or “connector body 24”) configured to retain the ferrule holder 18 within the housing 20. More specifically, a back end 26 of the ferrule 12 is received in a first portion 28 of the ferrule holder 18 and is secured therein in a known manner (e.g., press-fit, adhesive, molding the ferrule holder 18 over the back end 26 of the ferrule 12, etc.). The ferrule 12 and ferrule holder 18 may even be a monolithic structure in some embodiments. For convenience, the term “ferrule assembly” may be used to refer to the combination of the ferrule 12 and ferrule holder 18, regardless of whether these elements are separate components secured together or different portions of a monolithic structure.

The ferrule holder 18 is biased to a forward position within the housing 20 by a spring 32, which extends over a second portion 30 of the ferrule holder 18 that has a reduced cross-sectional diameter/width compared to the first portion 28. The spring 32 also interacts with internal geometry of the retention body 24, which may be secured to the housing 20 using a snap-fit or the like. For example, FIGS. 1 and 2 illustrate a rear portion of the housing 20 having cut-outs or slots 36 on opposite sides so as to define a split shroud. The retention body 24 has tabs 38 configured to be snapped into the slots 36 and retained therein due to the geometries of the components.

When the connector 10 is assembled as shown in FIG. 1, a front end 42 of the ferrule 12 projects beyond a front end 44 of the housing 20. The front end 42 presents the optical fiber 16 for optical coupling with a mating component (e.g., another fiber optic connector; not shown). Note that the ferrule 12 aligns the optical fiber 16 along a longitudinal axis 46. As will be described in greater detail below, the ferrule holder 18 (and, therefore, ferrule 12) is movable relative to the housing 20 along the longitudinal axis 46. Rotation about the longitudinal axis 46, however, is limited due to the keying features on the ferrule holder 18 and housing 20 cooperating with each other. The extent to which rotation is limited varies depending on whether the connector 10 is in an unmated or mated configuration, as will be discussed below.

In the embodiment shown in FIG. 2, the keying features on the ferrule holder 18 (“first keying features”) are in the form of keys 50 on opposite sides of the first portion 28. The keys 50 project radially outward from an outer surface 52 of the ferrule holder 18. Although the keys 50 are shown as cylindrical bosses, other shapes are possible.

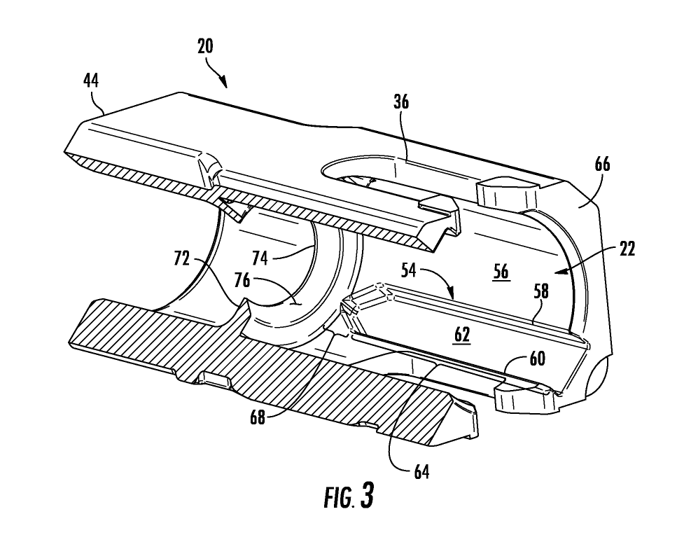

FIG. 3 illustrates how the keying features on the housing 20 (“second keying features”) in the particular embodiment shown are in the form of grooves 54 on an inner surface 56 of the housing 20. Each groove 54 has a width defined between opposed side walls 58, 60 and is configured to receive one of the keys 50 of the ferrule holder 18. Each groove 54 also has a bottom surface 62 between the opposed side walls 58, 60. Although the embodiment shown in the figures includes two of each keying feature (two of the grooves 54 and two of the keys 50), alternative embodiments may only have one of each keying feature. Alternatively, there may be more than two of each keying feature. Furthermore, in some embodiments, the keying feature(s) on the ferrule holder 18 may be in the form of one or more grooves while the keying feature(s) on the housing 20 may be in the form of one or more keys projecting radially inward from the inner surface 56.

Still referring to FIG. 3, each groove 54 includes a lead-in portion 64 that extends from a back end 66 of the housing 20 and an end portion 68 that terminates the groove 54 at an intermediate location between the front and back ends 44, 66 of the housing 20. The lead-in portion 64 slightly tapers in width as it extends toward the front end 44 of the housing 20. The end portion 68, on the other hand, sharply tapers from the lead-in portion 64 to the intermediate location so as to have a substantially V-shaped profile, which may be truncated. Thus, the side walls 58, 60 converge to an end point or surface of the groove 54 in the end portion 68.

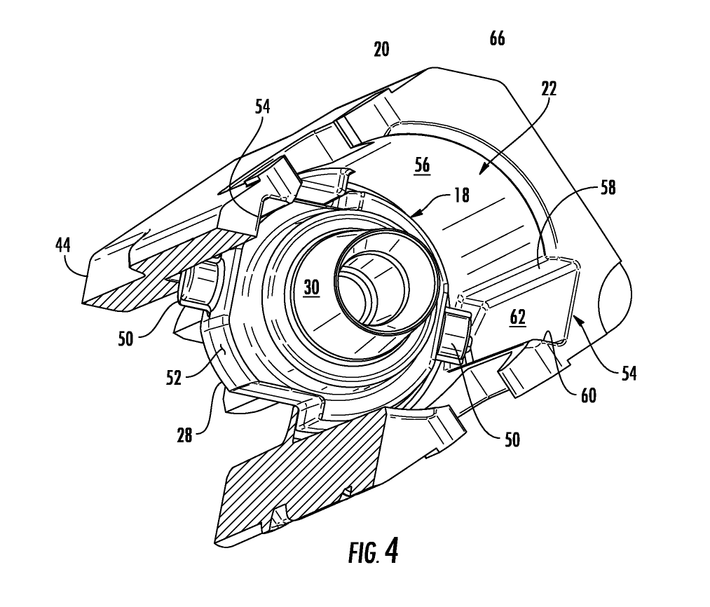

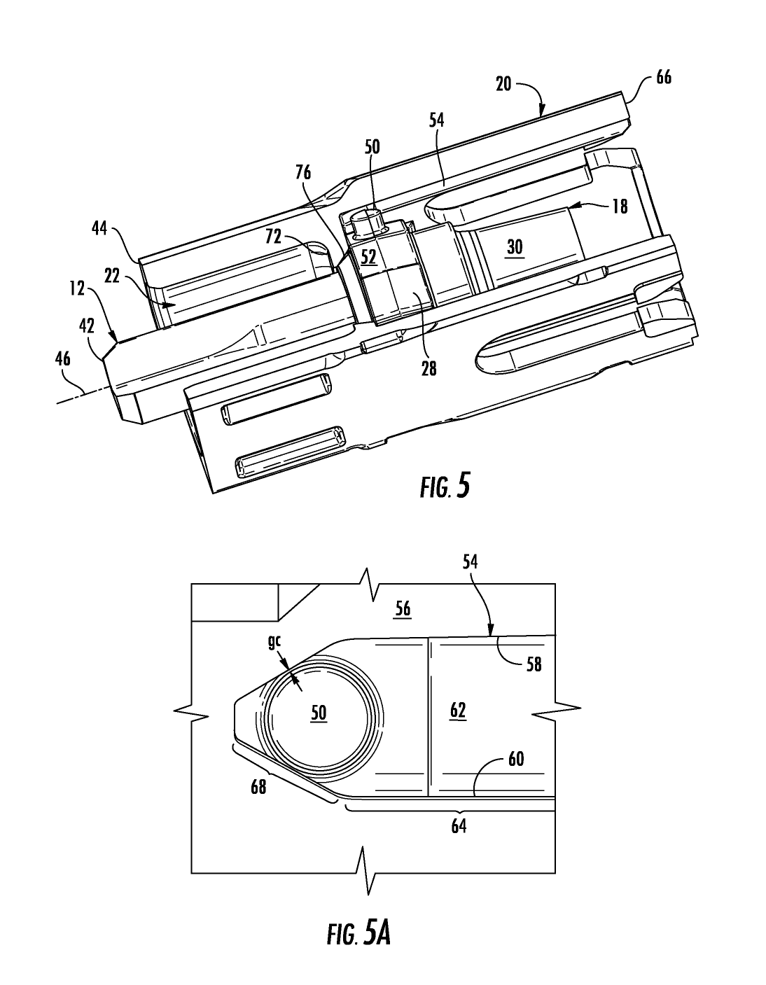

As shown in FIG. 4, the grooves 54 accommodate (i.e., receive) the keys 50 on the ferrule holder 18 when the ferrule holder 18 is inserted into the cavity 22 from the back end 66 of the housing 20. The ferrule holder 18 may be inserted until one or more surfaces on the ferrule holder 18 abut one or more surface inside the housing 20. More specifically, and with reference to FIGS. 3 and 5, the housing 20 includes a retention wall 72 extending radially inward from the inner surface 56. The retention wall 72 includes an opening 74 that is larger than the ferrule 12, but smaller than the first portion 28 of the ferrule holder 18. In the embodiment shown, the retention wall 72 has a chamfered surface 76 defining the opening 74. The first portion 28 of the ferrule holder 18 includes a conical surface 78 configured to abut the chamfered surface 76. The chamfered surface 76 and conical surface 78 have complementary geometries to provide a “self-centering” feature. That is, as the ferrule holder 18 is brought into contact with the retention wall 72, the complementary geometry helps align the ferrule assembly and housing along the longitudinal axis 46.

FIG. 5 illustrates the ferrule holder 18 in a forward position where further movement toward the front end 44 of the housing 20 is prevented by the retention wall 72. This forward position may represent an unmated condition of the connector 10 and, therefore, also be referred to as an “unmated position” of the ferrule assembly. The ferrule holder 18 is biased to this position by the spring 32 (FIG. 2). As illustrated by FIG. 5A, a minimum clearance or gap g_{c} is defined between each key 50 and corresponding groove 54 when the connector 10 is in the forward position. The minimum clearance g_{c} may be less than 50 μm, for example, for connector designs involving a 2.5 mm ferrule. In alternative embodiments, the minimum clearance g_{c} may even be zero such that there each key 50 is fully seated within/engaged with the corresponding groove 54 (i.e., no gaps present) when the connector 10 is in the forward position. Such engagement prevent the ferrule holder 18 from moving further forward within the housing 20 instead of, or in addition to, the retention wall 72 in some embodiments.

It should be noted that the minimum clearance g_{c} referred to above and shown in FIG. 5A is substantially in a circumferential direction about the longitudinal axis 46; measuring in the circumferential direction may approximate the minimum clearance g_{c}. There is also a gap in a radial direction between each key 50 and the bottom surface 62 of the corresponding groove 54. This latter gap is larger than the minimum clearance g_{c}, at least when the ferrule holder 18 is in the unmated position. For the purpose of this disclosure, references to the “minimum clearance” consistently refer to the gap in the circumferential direction (i.e., the gap between each key 50 and the side walls 58, 60 of the housing 60; the minimum clearance g_{c}).

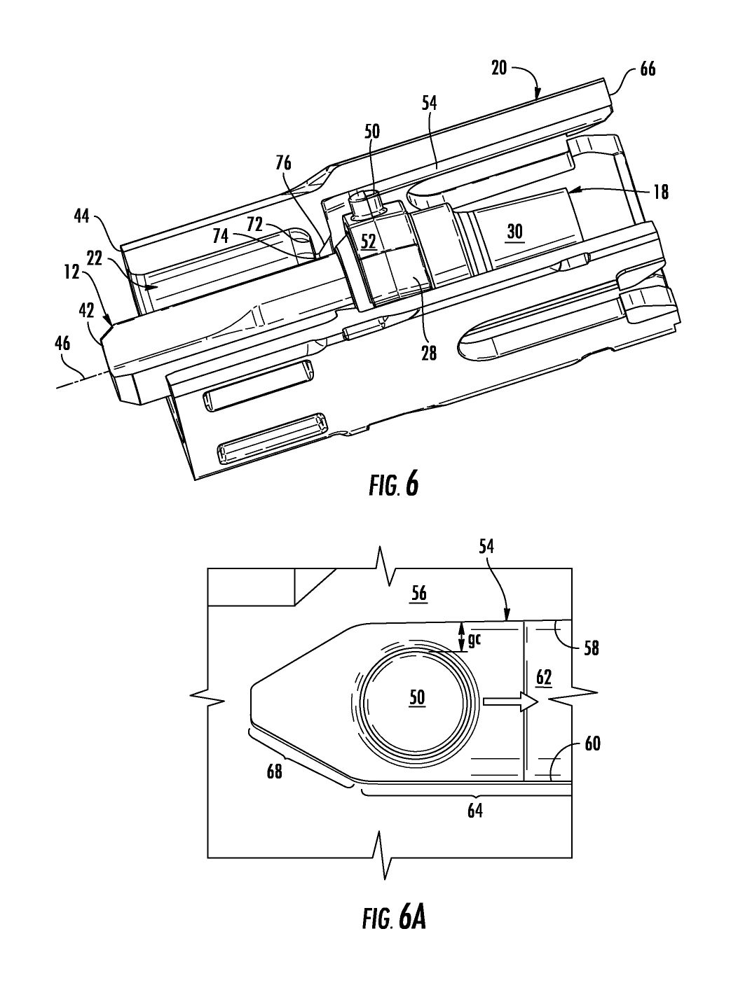

The ferrule holder 18 is able to move relative to the housing 20 in a rearward direction, along the longitudinal axis 46, by overcoming the biasing force provided by the spring 32. This may be the case during mating, where the ferrule 12 makes contact with a ferrule (not shown) of a mating connector to establish an optical connection/coupling between the optical fibers carried by the ferrules. To this end, FIG. 6 illustrates the ferrule holder 18 in a rearward position, which may represent a mated condition of the connector 10 and, therefore, also be referred to as a “mated position” of the ferrule assembly. Due to the grooves 54 expanding in width as the grooves 54 extend toward the back end 66 of the housing 20, the minimum clearance g_{c} between each key 50 and corresponding groove 54 increases as the ferrule holder 18 moves in the rearward direction. Thus, the minimum clearance g_{c} between each key 50 and corresponding groove 54 is greater in the rearward/mated position of the ferrule assembly than in the forward/unmated position.

There are several advantages associated with the above-described arrangement. For example, as can be appreciated, the extent to which the ferrule assembly can rotate relative to the housing 20 about the longitudinal axis 46 is limited by the minimum clearance between the keys 50 and grooves 54. The minimum clearance defines a tolerance for rotational misalignment between the ferrule assembly and housing 20. When the connector 10 is in an unmated condition (FIGS. 5 and 5A), the ferrule assembly is in the forward position and the minimum clearance is relatively small. In other words, there is a tight tolerance for rotational misalignment when the connector 10 is in an unmated condition. Although a tight fit between keying features normally increases the chances of forces being transferred from the housing 20 to the ferrule assembly and changing the orientation and/or position of the optical fiber(s) in the ferrule 12, this is less of a concern when the connector 10 is in an unmated condition because optical performance is not being measured; there is no optical connection at this point.

When the connector 10 is in a mated condition (FIGS. 6 and 6A), the ferrule assembly is in a rearward position and the minimum clearance between each key 50 and corresponding groove 54 is greater. There is a greater tolerance for rotational misalignment such that the chances of forces being transferred from the housing 20 to the ferrule assembly and affecting optical performance is reduced. Thus, the minimum clearance between the first and second keying features changes based on whether the connector 10 is in an unmated or mated condition. This allows the arrangement to be optimized for each condition. The small minimum clearance in the unmated condition helps ensure that the ferrule assembly maintains a particular rotational orientation until an optical connection is established, which is particularly important for connectors having APC or tuned ferrules. Once the optical connection has been established by mating the connectors, the minimum clearance increases so that the optical connection is less likely to be affected by the transfer of forces from the housing 20 to the ferrule assembly.

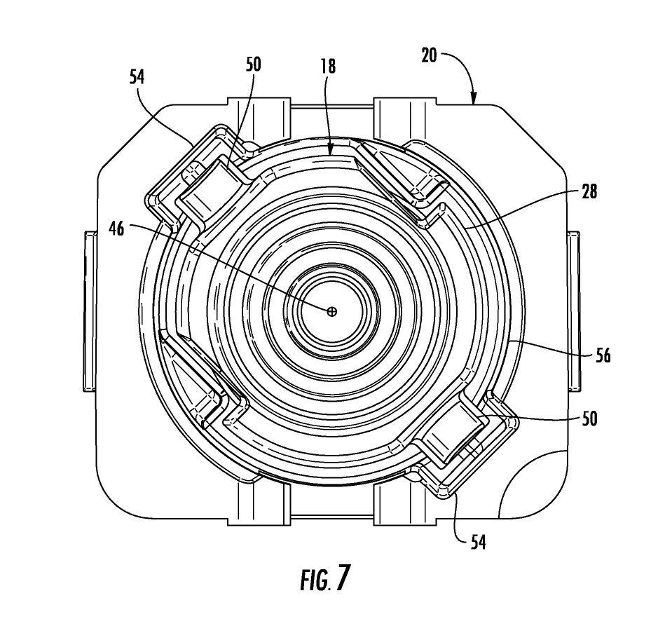

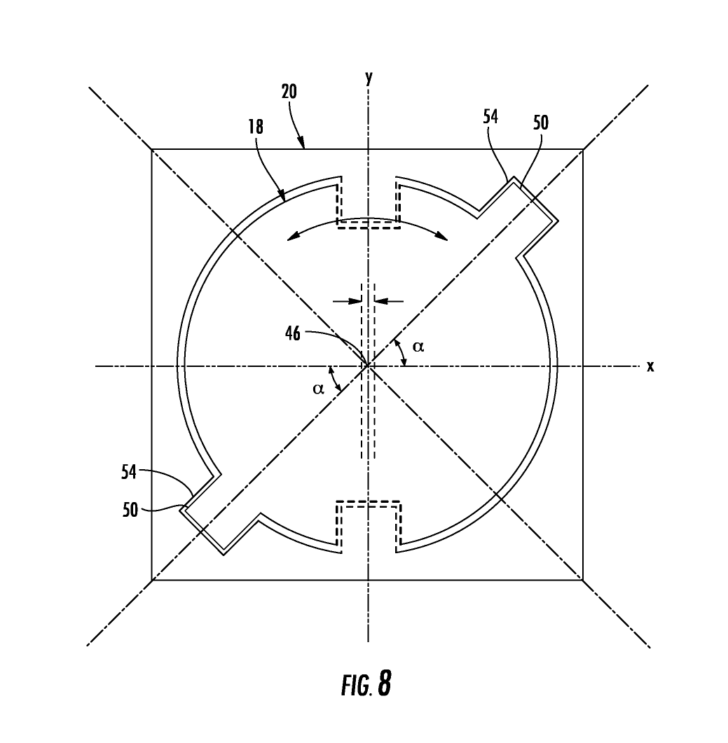

Another advantage associated with the particular embodiment shown relates to the location of the keying features. As shown in FIG. 7, the housing 20 has a substantially rectangular profile in a plane perpendicular to the longitudinal axis 46, and the keying features are located in a corner region of the housing. Thus, each groove 54 in the housing 20 extends from the inner surface 56 toward a corner region of the substantially rectangular profile. The arrangement is schematically illustrated in FIG. 8, which also shows a conventional arrangement of keying features in hidden lines for a comparison.

To facilitate discussion, reference will be made to a Cartesian coordinate system having a z-axis defined by the longitudinal axis 46 (direction into page in FIG. 8). Adjacent sides of the housing 20 are perpendicular to an x-axis and y-axis of the Cartesian coordinate system. As shown in FIG. 8, the grooves 54 in the inner surface 56 of the housing 20 are substantially aligned with a plane offset from the x-axis by 45° . Stated differently, the grooves 54 are substantially aligned with a 45° plane through the z-axis, with the angular offset of the 45° plane being measured from the x-axis. In other embodiments, the grooves 54 may simply intersect the 45° plane, or be positioned anywhere between a 30° plane and 60° plane measured from the x-axis. The angle α in FIG. 8 represents the angular offset of the grooves 54.

As can be appreciated from FIG. 8, the angular offset results in the grooves 54 being positioned further from the z-axis compared to a conventional arrangement where the keying features are aligned with the y-axis (as shown by hidden lines in FIG. 8) or x-axis. This increases the circumferential distance over which the keys 50 can travel for a given rotational precision between the ferrule assembly and housing 20 about the z-axis. In other words, to maintain the same rotational constraint about the z-axis as the conventional arrangement, the spacing between the keys 50 and grooves 54 must allow for increased travel of the keys 50 relative to the grooves 54 in the circumferential direction. This results in a greater spacing between the keys 50 and grooves 54 compared to the conventional arrangement. Thus, the manufacturing tolerances for the keys 50 and grooves 54 can be relaxed/increased due to the additional spacing/looser fit. Alternatively, if the same manufacturing tolerances for the keys 50 and grooves 54 are maintained (i.e., the same spacing between the keys 50 and grooves 54 as in the conventional arrangement), the rotational precision is increased (i.e., there is less ability for the ferrule assembly to rotate relative to the housing 20 about the longitudinal axis 46).

Referring back to FIG. 7, the keys 50 are located on diametrically-opposite locations of the outer surface 28 of the ferrule holder 18, and the grooves 54 are located at diametrically-opposite locations on the inner surface 56 of the housing 20. To ensure that the ferrule assembly is inserted into the housing 20 with a particular rotational orientation, the outer surface 28 of the ferrule holder 18 and inner surface 56 of the housing 20 have complementary rotationally asymmetric profiles about the longitudinal axis 46. Although ensuring correct rotational orientation may alternatively be achieved through an asymmetrical arrangement of the keying features, avoiding the need to do so allows each keying feature in a dual keying feature arrangement to be located in a corner region of the housing 20. The advantages associated with locating the keys in this manner are discussed above. The same principles could be applied to embodiments having a quadruple keying feature arrangement.

It should be noted that although locating the keying features in the manner described above provides certain advantages that complement the advantages associated with the different minimum clearances in the unmated and mated positions of the ferrule assembly, embodiments will be appreciated involving one of these aspects and not the other. For example, embodiments will be appreciated where the first and second keying features are located in a corner region of the substantially rectangular profile defined by the housing, with the minimum clearance between the first and second keying features being the same regardless of whether the connector is in an unmated or mated condition. Conversely, embodiments will be appreciated where the feature of a different minimum clearance between the first and second keying features in the unmated and mated conditions is incorporated without locating the first and second keying features in a corner region of the housing.

Those skilled in the art will appreciate that other modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A fiber optic connector, comprising:
a ferrule assembly having a ferrule extending along an longitudinal axis and a ferrule holder from which the ferrule extends, the ferrule being configured to support at least one optical fiber, and the ferrule holder having an outer surface with a first keying feature; and
a housing in which the ferrule holder is received, the housing having an inner surface with a second keying feature that cooperates with the first keying feature to limit rotation of the ferrule holder about the longitudinal axis;
wherein the ferrule assembly is movable relative to the housing along the longitudinal axis between an unmated position and a mated position, the ferrule holder being closer to a front end of the housing in the unmated position than in the mated position; and
wherein a minimum clearance between the first keying feature and second keying feature is greater in the mated position than in the unmated position.

2. The fiber optic connector according to claim 1, wherein the ferrule holder includes a plurality of the first keying features and the housing includes a plurality of the second keying features, with each of the first keying features cooperating with a corresponding one of the second keying features to limit rotation of the ferrule holder about the longitudinal axis.

3. The fiber optic connector of claim 1, wherein the ferrule assembly is spring-biased toward the unmated position, and further wherein the first keying feature engages the second keying feature in the unmated position such that the minimum clearance between the first keying feature and second keying feature is zero in the unmated position.

4. The fiber optic connector of claim 1, wherein the first keying feature comprises a key projecting from an outer surface of the ferrule holder, and further wherein the second keying feature comprises a groove on the inner surface of the housing, the groove having at least a portion that tapers in width in a direction toward the front end of the housing.

5. The fiber optic connector of claim 4, wherein the groove includes a lead-in portion extending from a back end of the housing and an end portion that terminates the groove at an intermediate location between the front and back ends of the housing, the end portion of the groove having a substantially v-shaped profile.

6. The fiber optic connector of claim 4, wherein the housing has a substantially rectangular profile in a plane perpendicular to the longitudinal axis, and further wherein the groove extends from the inner surface of the housing toward a corner of the substantially rectangular profile.

7. The fiber optic connector of claim 4, wherein:
the longitudinal axis defines a z-axis of a Cartesian coordinate system;
adjacent sides of the housing are perpendicular an x-axis and y-axis of the Cartesian coordinate system; and
the groove in the inner surface of the housing is located between a 30° plane and a 60° plane extending along the z-axis, the 30° plane and 60° plane being measured from the x-axis.

8. The fiber optic connector of claim 7, wherein the groove in the inner surface of the housing intersects a 45° plane extending along the z-axis, the 45° plane being measured from the x-axis.

9. The fiber optic connector of claim 4, wherein the key comprises a cylindrical boss.

10. The fiber optic connector of claim 4, wherein the inner surface of the housing is substantially cylindrical such that the groove is in a radially outward direction.

11. The fiber optic connector of claim 1, wherein the first keying feature comprises a groove in an outer surface of the ferrule holder, and further wherein the second keying feature comprises a key projecting from an inner surface of the housing.

12. The fiber optic connector of claim 1, wherein the inner surface of the housing and outer surface of the ferrule holder have complementary rotationally asymmetric profiles about the longitudinal axis.

13. The fiber optic connector of claim 1, wherein the ferrule has an outer diameter of about 2.5 mm, and further wherein the minimum clearance between the first and second keying features is less than 50 μm in the unmated position and greater than 100 μm in the mated position.

14. The fiber optic connector of claim 1, wherein:
the housing includes an internal retention wall having an opening through which the ferrule extends, the opening being defined by a chamfered surface on the retention wall; and
the ferrule holder has a first portion larger than the opening in the retention wall, the first portion including a conical surface configured to abut the chamfered surface of the retention wall when the ferrule assembly is in the unmated position.

15. A fiber optic connector, comprising:
a ferrule assembly having a ferrule extending along a longitudinal axis and a ferrule holder from which the ferrule extends, the ferrule being configured to support at least one optical fiber, and the ferrule holder having an outer surface with a first keying feature; and
a housing having a cavity in which the ferrule assembly is received, the ferrule assembly being movable relative to the housing along the longitudinal axis, and the housing having an inner surface with a second keying feature that cooperates with the first keying feature to limit rotation of the ferrule assembly about the longitudinal axis;
wherein:
the ferrule assembly is biased toward a forward position in the housing in which a portion of the ferrule holder abuts a portion of the housing to retain the ferrule assembly within the housing;
the first keying feature comprises one of a key or a groove, and the second keying feature comprises the other of the key or the groove; and
a minimum clearance between the key and the groove increases when the ferrule assembly moves in a rearward direction from the forward position.

16. The fiber optic connector of claim 15, wherein the ferrule holder includes a plurality of the first keying features and the housing includes a plurality of the second keying features, with each of the first keying features cooperating with a corresponding one of the second keying features to limit rotation of the ferrule holder about the longitudinal axis.

17. The fiber optic connector of claim 15, wherein:
the housing includes an internal retention wall having an opening through which the ferrule extends, the opening being defined by a chamfered surface on the retention wall; and
the ferrule holder has a first portion larger than the opening in the retention wall, the first portion including a conical surface configured to abut the chamfered surface of the retention wall when the ferrule assembly is in the forward position.

18. A fiber optic connector, comprising:
a ferrule assembly having a ferrule extending along a longitudinal axis and a ferrule holder from which the ferrule extends, the ferrule being configured to support at least one optical fiber, and the ferrule holder having an outer surface and two keys projecting radially outward from diametrically opposed locations on the outer surface; and
a housing in which the ferrule holder is received, the housing having an inner surface with two grooves extending from a back end of the housing;
wherein:
the ferrule assembly is movable relative to the housing along the longitudinal axis between an unmated position and a mated position, the ferrule holder being closer to a front end of the housing in the unmated position than in the mated position;
each key on the ferrule holder is received in a corresponding one of the grooves on the inner surface of the housing and cooperates with the corresponding groove to limit rotation of the ferrule holder about the longitudinal axis; and
a minimum clearance between each key and the corresponding groove is greater in the mated position than in the unmated position.

19. The fiber optic connector of claim 18, wherein:
the longitudinal axis defines a z-axis of a Cartesian coordinate system;
adjacent sides of the housing are perpendicular an x-axis and y-axis of the Cartesian coordinate system; and
the groove in the inner surface of the housing is located between a 30° plane and a 60° plane extending along the z-axis, the 30° plane and 60° plane being measured from the x-axis.

20. The fiber optic connector of claim 19, wherein the groove in the inner surface of the housing intersects a 45° plane extending along the z-axis, the 45° plane being measured from the x-axis.
